(19) United States
(12) Patent Application Publication
(10) Pub. No.: US 2005/0280558 A1
(43) Pub. Date: Dec. 22, 2005

(54) A remote control device containing a Global Positioning System (GPS) device emitting a geographical signal processed in this same remote control to produce a signal which then elicits the selection of a map file recorded on a Digital Video Disc (DVD) on a separate digital video disc player connnected to a video display device also separate from this remote control toward display and mainpulation of this and other map files and the geographic position of this remote control

(75) Inventor: Christopher Adam McLeod, Toronto, Ontario (CA)

Correspondence Address: CHRISTOPHER ADAM MCLEOD, 622 80 FRONT STREET EAST, TORONTO, ON, L3R 1B8, CA

(73) Assignee: Christopher Adam McLeod, Toronto (CA)

(21) Appl. No.: 10/710,100

(22) Filed: Jun. 18, 2004

(51) Int. Cl. G08G 1/123

(52) U.S. Cl. 340/995.1; 340/539.13

(57) ABSTRACT

A remote control device containing a Global Positioning System (GPS) device emitting a geographical signal processed in this same remote control to produce a signal which then elicits the selection of a map file recorded on a Digital Video Disc (DVD) on a separate digital video disc player connected to a video display device also separate from this remote control toward display and manipulation of this and other map files and the geographic position of this remote control.

### COPYRIGHT STATEMENT

This invention and its description are copyright to Christopher Adam McLeod, Jun. 19, 2004.

### FEDERAL RESEARCH STATEMENT

[No Federal funds used in the development of this invention.]

### BACKGROUND OF INVENTION

1. Field of the Invention

This invention falls into the field of using Global Positioning Satellites with a storage device wherein the position is utilized in combination with a cartographic or topographic representation, chart, atlas, etc. to either retrieve or store information.

2. Description of Prior Art

Existing portable Global Positioning Systems work by receiving a plurality of (three or more in general) artificial satellites and measuring the current position of the receiver by using the received radio signals. This signal may optionally be displayed on a display device embedded within the portable GPS. Moreover, map files selected on the basis of the signals received may also be displayed on the display embedded into the portable GPS device. Drawbacks with this system include the embedding of fragile display devices within the portable display, and having to incorporate both significant processing power within the portable device for the display and manipulation of map files and the geographic position of the portable device, and having to provide very large data storage capacity required by data-rich map and other geographic data files.

### SUMMARY OF INVENTION

The present invention has been made in consideration of the above problems in the prior art, and has as its object the use of a Global Positioning Systems device within a remote control controlling a Digital Video Disc player and the placement of the display component in a separate display device connected to the same Digital Video Disc player. The data and some computer programs are stored on removable Digital Video Discs played in this same Digital Video Disc Player, and part of the processing load for selection, display, and manipulation of these map and other geographical data files is be done by processors in the same Digital Video Disc player. Selection of map and other geographical data is done using processing both from the reception of artificial satellite signals through which geographic position may be calculated, and using processing from user input on the remote control input devices such as keys. wherein the Global Positioning System device means a device capable of receiving and processing a plurality of radio signals from artificial satellites and processing these to calculate the geographical position of that same device. wherein the remote control means a portable (usually handheld) device that contains at least some keys for input as well optionally other devices for input such as dials. This same remote control then processes and transmits this input to a separate electronic device that is designed to receive the signals and carry out the requested electronic tasks. wherein a input device on a remote control is an electronic mechanism producing a signal that elicits a predefined reaction in the electronic device which it controls via the use of predefined key codes, usually infra-red in substance. wherein the Digital Video Disc player refers to an electronic machine capable of reading and processing the content of digital video discs for further tasks such as video and audio output according to that signal. wherein processing a signal refers to reception of that signal and digital or analog processing carried out by an electronic microprocessor to transform that signal into a new signal. wherein a map refers to a cartographic display of geographical data. wherein a geographical file refers to a data file containing data with at least some geographical positional information, but not necessarily with a cartographic display component. wherein artificial satellites refer to devices placed in the atmosphere by humans to emit signals of use on the surface of the earth. wherein selection means the electronics choice of files as guided by a microprocessor processing a signal. wherein display means video output to a device recognizable to the human eye wherein manipulation means use of the displayed map files, other geographic data files, and the signal from the Geographic Positioning System device to carry some electronic task requested by the user of the remote control.

### BRIEF DESCRIPTION OF DRAWINGS

FIG. 1 is a schematic view showing the arrangement of a position measuring system according to the first embodiment of the present invention;

### DETAILED DESCRIPTION

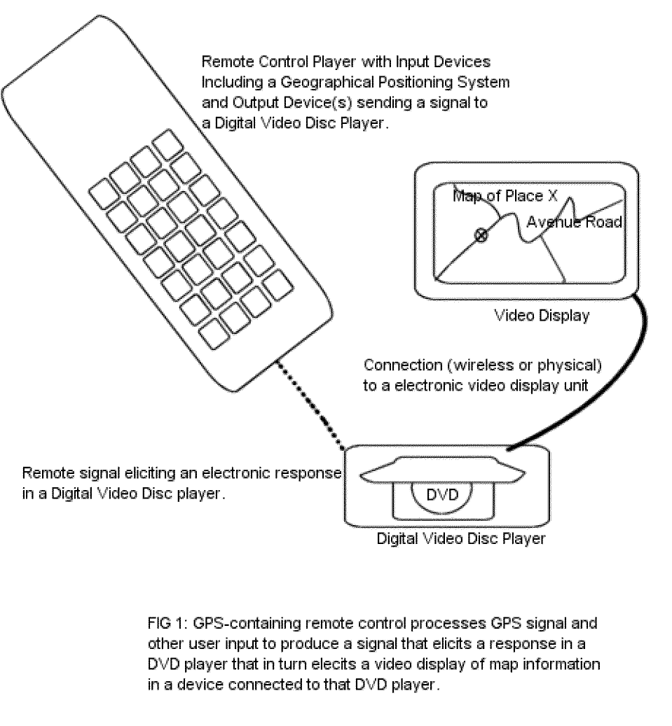

FIG. 1 describes a system wherein a remote control device operated by a user shows the user maps on a video display device, and optionally shows the position of the user on that map, and allows for display of other maps as well as manipulation of this data for other purposes by use of other devices such as keys on the remote control that input signals to the microprocessors in the remote control and in the DVD player connected to that screen. The everyday user of paper maps for visualizing and calculating geographic orientation, arrival time, routing performs considerable processing of geographic data information within the user's brain. Current portable Global Positioning Systems available combine the video display, data storage, and data processing all into the same portable unit containing the Global Positioning Systems device. Map files and geographic databases are very large and require expensive storage methods when compressed into the limited space available inside a portable Global Positioning System. Further, the size of a video display device embedded within a portable GPS is limited. Further, expensive and power-hungry processors must be incorporated into what is usually a battery-driven DC device. U.S. Pat. No. 6,016,606 is typical of such a system wherein all functions are embedded in a single portable device. Durability of the system must also be called into question as both a video display system and memory devices that are liable to mechanical failure. The gist of this system is to add a Global Positioning Systems device to the remote control, usually at least optionally DC battery-driven, that is commonly used to control a standard commercial Digital Video Disc Player. By using a microprocessor within the remote control, the output signal of the remote control player can transmit information from that processed to be used to execute such tasks as selecting a map file recorded on a Digital Video Disc that is read and processed by the standard DVD player, and then displayed on a video display device such as an attached video screen or the user's home television, this connection effected either by cable or wireless means. Further processing can be done, for example the selection of map files neighbouring to the file originally selected by the user's Global Positioning System position signal, or display of the user's position, or routing, or audio support. This processing could be elicited of the Digital Video Player by the pressing of additional input devices on the remote control such as keys or dial selection devices, even voice command. The effect of this would be to have a removable electronic atlas on DVD, with all the inherent possibilities for use of that digital video and audio information.

1. What I claim is to be the sole inventor of the concept of incorporating a Global Positioning System into a device which processes that geographic information signal and then uses it to remotely control a Digital Video Player to read, process, display, and manipulate map and other geographic data files already recorded on a removable Digital Video Disc.
